(19) United States
(12) Patent Application Publication
(10) Pub. No.: US 2016/0188638 A1
(43) Pub. Date: Jun. 30, 2016

(54) APPARATUS AND METHOD FOR MANAGING USAGE OF A DATABASE SYSTEM RESOURCES BY CONCURRENT DATABASE USERS OF A DATABASE SYSTEM

(71) Applicant: Teradata US, Inc., Dayton, OH (US)

(72) Inventor: Hoa Thu Tran, Escondido, CA (US)

(73) Assignee: Teradata US, Inc., Dayton, OH (US)

(21) Appl. No.: 14/681,174

(22) Filed: Apr. 8, 2015

Related U.S. Application Data
(60) Provisional application No. 62/098,030, filed on Dec. 30, 2014.

(51) Int. Cl. G06F 17/30; H04L 12/26; H04L 12/911

(52) U.S. Cl. CPC G06F 17/30289; H04L 47/78; H04L 43/08

(57) ABSTRACT

An apparatus is provided for managing usage of database system resources by concurrent database users of a database system. The apparatus comprises a processor and a storage device communicatively coupled with the processor. The processor is programmed to (i) determine a number of in-use Access Module Processor Worker Tasks (AWTs) based upon at least one system-defined or user-definable Resource Limit rule, (ii) take a difference between the number of in-use AWTs and an AWT limit, and (iii) set the difference equal to a number of available AWTs for a new database job or request.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 62/098,030, entitled “APPARATUS AND METHOD FOR MANAGING USAGE OF DATABASE SYSTEM RESOURCES BY CONCURRENT DATABASE USERS OF A LARGE DATABASE SYSTEM,” filed on Dec. 30, 2014, by Hoa Thu Tran.

### TECHNICAL FIELD

The present disclosure relates to computer systems, and is particularly directed to an apparatus and method for managing usage of system resources by concurrent users of a computer system such as a database system.

### BACKGROUND

A database of a database system is a collection of stored data that is logically related and that is accessible by one or more users or applications. A popular type of database is the relational database management system (RDBMS), which includes relational tables, also referred to as relations, made up of rows and columns (also referred to as triples and attributes). Each row represents an occurrence of an entity defined by a table, with an entity being a person, place, thing, or other object about which the table contains information.

Modern database systems execute a variety of query requests concurrently and operate in a dynamic environment of cooperative systems, each comprising of numerous hardware components subject to failure or degradation. The need to regulate concurrent hardware and software “events” has led to the development of a field which may be generically termed “Workload Management”.

Workload management techniques focus on managing or regulating a multitude of individual yet concurrent requests in a database system by effectively controlling resource usage within the database system. Resources may include any component of the database system, such as CPU (central processing unit) usage, hard disk or other storage means usage, or disk I/O (input/output) usage. Workload management techniques fall short of implementing a system regulation, as they do not manage unforeseen impacts, such as unplanned situations (e.g., a request volume surge, the exhaustion of shared resources, or external conditions like component outages) or even planned situations (e.g., systems maintenance or data load).

Contemporary workload management systems allow users to establish Service Level Goals (SLGs) for workloads (WDs). The SLGs are primarily used for reporting purposes, e.g., to gauge the success of the workload's performance and to note trends with respect to meeting those SLGs. One of the options is to establish an SLG based on response time with a service percentage. A second option is to define the SLG based on throughput rate (i.e., completions).

A second use of the SLGs is to automatically detect when SLGs are being missed. For example, one of the primary approaches used by database administrators (DBAs) and System Administrators is to first identify that there is a problem with their SLGs. Investigations into why will typically start with analysis at the system-level. if the system is not 100% busy and does not have heavy skewing, then typically the DBA will next check for blocked sessions.

However if the CPU is 100% busy, then the number of active sessions will be checked for unusually high concurrency levels. If some workloads have too many active sessions, then appropriate actions may be taken, such as to limit concurrency, to abort queries, and/or to make adjustments to Priority Scheduler weights.

If the CPU is 100% busy and active sessions appear appropriate, the DBA may next check the CPU usage by WD and/or session to evaluate if there is a runaway query. From here, the DBA may take the appropriate action, e.g., to abort the offending request.

Notably, these investigations are triggered based on knowing that SLGs are being missed, enabling the DBA to act manually or automatically to resolve the situation, and bring WD performance back to SLG conformance.

There are a number of different resources which can be monitored for effective parallel usage across the database system. The different resources include CPU usage, disk I/O usage, memory usage, and network usage, for examples. The resources usually require careful management because system performance and active requests are affected when these resources are depleted.

One way to prevent the depletion of resources is to limit concurrent requests. However, a drawback in limiting concurrent requests is that it is difficult to select the optimal concurrency limit because the resource requirement of each request can vary significantly. If the concurrency limit is set too high and many requests with large requirements are running concurrently, then resource depletion still occurs. If the concurrency limit is set too low, then the database system may be underutilized.

For example, a Teradata Data Stream Architecture (DSA) job may use from two to 55 Access Module Processor (AMP) Worker Tasks depending upon the type of job and the attributes of the tables. A DSA Backup job requires only two AMP Worker Tasks (AWTs), but a DSA Restore job may require anywhere from three to 55 AWTs in the intermediate phases of the job and only two AWTs in the last phase of the job. It is therefore difficult to select the optimal concurrency limit to prevent DSA jobs from using too many AWTs.

Another consideration is that a DBA may want to set different resource usage limits for different groups of requests, such as certain users, certain accounts, and the like. For example, in a system with 80 AWTs, two complex DSA Restore jobs can use up all AWTs but tens of simple DSA Restore jobs can run concurrently without depleting AWTs. In this example case, a DBA may want to limit the DSA jobs to use at most 55 AWTs. Moreover, the DBA may want to reserve a certain number of AWTs (e.g., five AWTs) of the 55 AWTs for the DBA to use. Again, it is therefore difficult to select the optimal concurrency limit to prevent DSA jobs from using too many AWTs.

It would be desirable to provide a database management system which overcomes above-mentioned drawbacks and which manages usage of database system resources to prevent excessive usage of system resources by concurrent database users.

### SUMMARY

A disclosed embodiment provides an apparatus for facilitating workload management of a database system by concurrent database users. The apparatus comprises a processor and a storage device communicatively coupled with the processor. The processor is programmed to (i) determine a number of in-use Access Module Processor Worker Tasks (AWTs) based upon at least one system-defined or user-definable Resource Limit rule, (ii) take a difference between the number of in-use AWTs and an AWT limit, and (iii) set the difference equal to a number of available AWTs for a new database job or request.

### BRIEF DESCRIPTION OF THE DRAWINGS

Aspects of the present disclosure are best understood from the following detailed description when read with the accompanying figures, in which

FIG. 1 depicts a diagrammatic representation of an exemplary architecture for a database system that is suited to be managed for resource usage in accordance with disclosed embodiments.

FIG. 2 is a diagrammatic representation of a parsing engine used in the database system of FIG. 1.

FIG. 3 is a diagrammatic representation of parser processing in FIG. 2.

FIGS. 4-7 are block diagrams of a workload management system for administering workload of a database system in accordance with disclosed embodiments.

FIG. 8 is a flowchart that depicts processing of an example routine to facilitate incrementing the number of in-use AWTs when a job or request is starting.

FIG. 9 is a flowchart that depicts processing of an example routine to facilitate determining if the number of required Access Module Processor Worker Tasks (AWTs) for an assigned request exceeds the number of available AWTs in accordance with disclosed embodiments.

FIGS. 10A and 10B are a flowchart that depicts processing of an example routine to facilitate decrementing the number of in-use AWTs when a job or request is finishing or transitioning and incrementing the number of in-use AWTs when a delayed job or request is starting.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

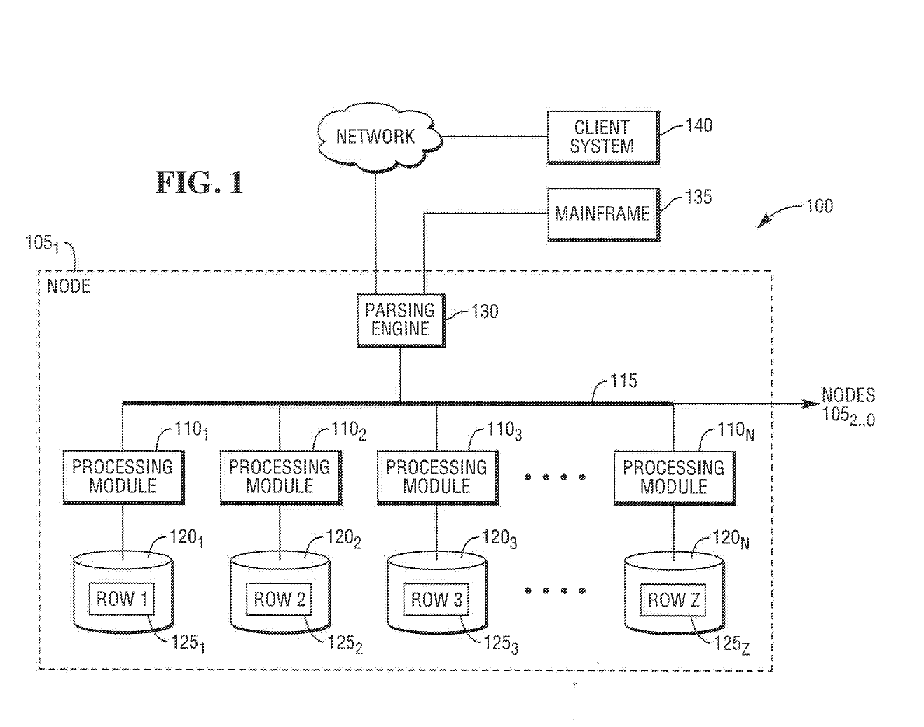

FIG. 1 depicts a diagrammatic representation of an exemplary architecture for a large database system (DBS) 100, such as a Teradata Active Data Warehousing System, that is suited to be managed for resource usage in accordance with disclosed embodiments. The database system 100 includes a relational database management system (RDBMS) built upon a massively parallel processing (MPP) system. Other types of database systems, such as object-relational database management systems (ORDBMS) or those built on symmetric multi-processing (SMP) platforms, are also suited for use. The depicted and described architecture is exemplary only and is chosen to facilitate an understanding of the disclosed embodiments.

Many millions or billions of records may be managed by the database system 100. FIG. 1 shows a sample architecture for one node 105₁ of the DBS 100. The DBS node 105₁ includes one or more processing modules 110_{1 . . . N}, connected by a network 115 that manage the storage and retrieval of data in data storage facilities 120_{1 . . . N}. Each of the processing modules 110_{1 . . . N} may be one or more physical processors or each may be a virtual processor, with one or more virtual processors running on one or more physical processors.

The system stores data in one or more tables in the data storage facilities 120_{1 . . . N}. Rows 125_{1 . . . Z} of the tables are stored across multiple data storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data storage facilities 120_{1 . . . N} in response to queries received from a user at a mainframe 135 or a client computer 140. The DBS 100 usually receives queries in a standard format, such as SQL.

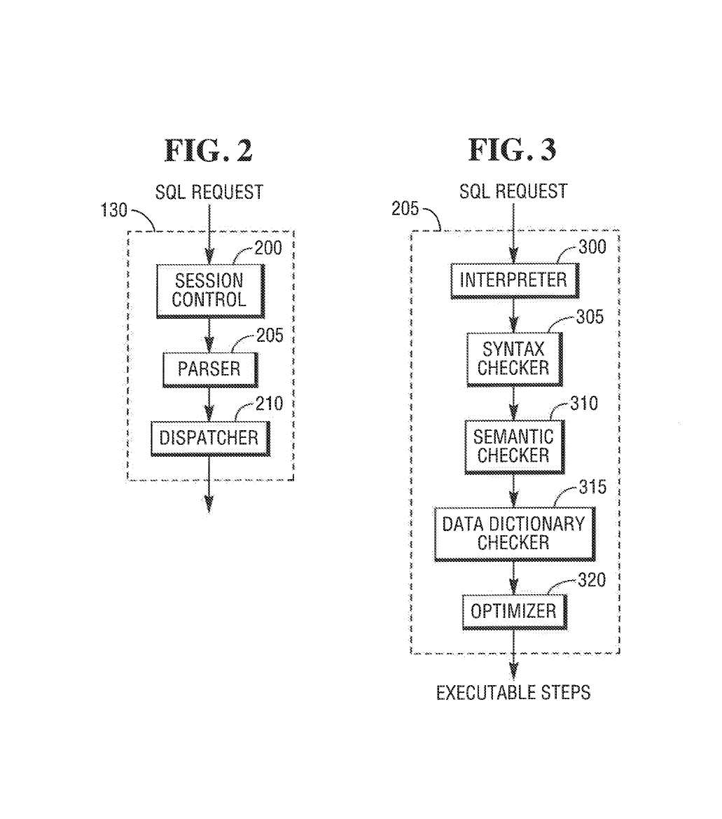

In one example system as illustrated in FIG. 2, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access. Once the session control 200 allows a session to begin, a user lay submit a SQL request that is routed to the parser 205.

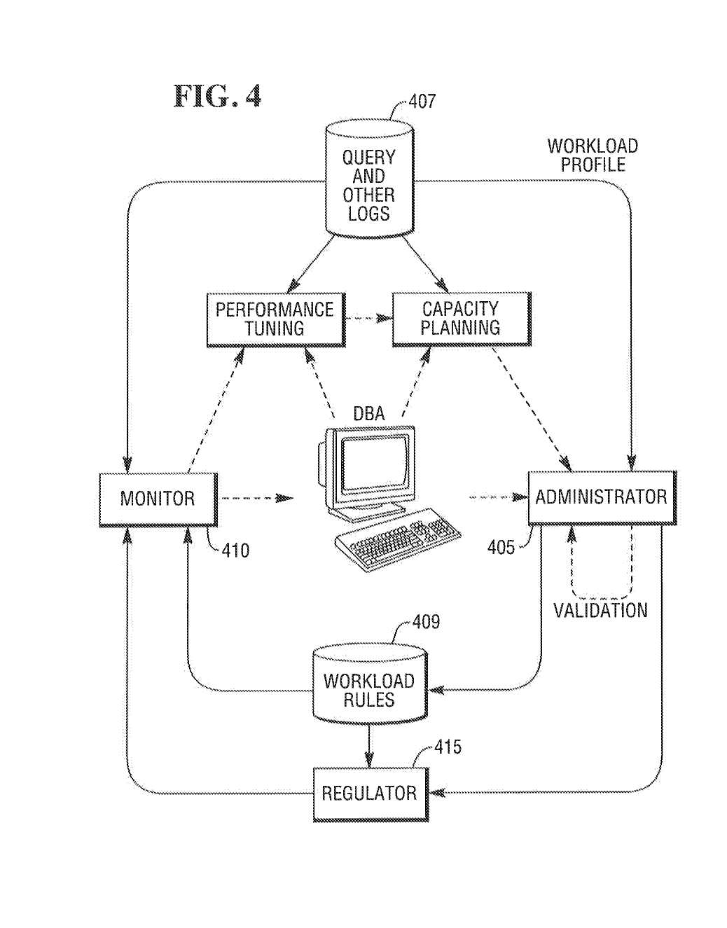

As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320) that develops the least expensive plan to perform the request.

The DBS 100 described herein accepts performance goals for each workload as inputs, and dynamically adjusts its own performance, such as by allocating DBS resources and throttling back incoming work, in one example system, the performance parameters are called priority scheduler parameters. When the priority scheduler is adjusted, weights assigned to resource partitions and allocation groups are changed. Adjusting how these weights are assigned modifies the way access to the CPU, disk and memory is allocated among requests. Given performance objectives for each workload and the fact that the workloads may interfere with each other's performance through competition for shared resources, the DBS 100 may find a performance setting that achieves one workload's goal but makes it difficult to achieve another workload's goal.

The performance goals for each workload will vary widely as well, and may or may not be related to their resource demands. For example, two workloads that execute the same application and DBS code could have differing performance goals simply because they were submitted from different departments in an organization. Conversely, even though two workloads have similar performance objectives, they may have very different resource demands,

The system includes a “closed-loop” workload management architecture capable of satisfying a set of workload-specific goals. In other words, the system is a goal-oriented workload management system capable of supporting complex workloads and capable of self-adjusting to various types of workloads. In Teradata, the workload management system is generally referred to as Teradata Active System Management (TASM).

The system's operation has four major phases: 1) assigning a set of incoming request characteristics to workload groups, assigning the workload groups to priority classes, and assigning goals (called Service Level Goals or SLGs) to the workload groups, 2) monitoring the execution of the workload groups against their goals, 3) regulating (adjusting and managing) the workload flow and priorities to achieve the SLGs, and 4) correlating the results of the workload and taking action to improve performance.

The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (DBA).

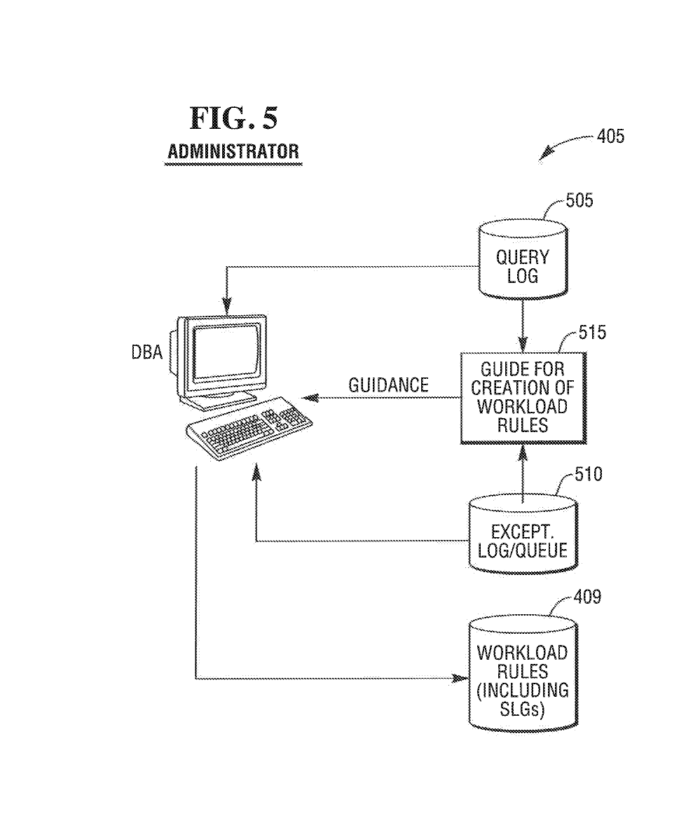

The system includes the following components (illustrated in FIG. 4):

1) Administrator (block 405): This component provides a graphical user interface (GUI) to define workloads and their SLGs and other workload management requirements. The administrator 405 accesses data in logs 407 associated with the system, including a query log, and receives capacity planning and performance tuning inputs as discussed above. The administrator 405 is a primary interface for the DBA. The administrator also establishes workload rules 409, which are accessed and used by other elements of the system,

2) Monitor (block 410): This component provides a top level dashboard view, and the ability to drill down to various details of workload group performance, such as aggregate execution time, execution time by request, aggregate resource consumption, resource consumption by request, etc. Such data is stored in the query log and other logs 407 available to the monitor 410. The monitor 410 also includes processes that initiate the performance improvement mechanisms listed above and processes that provide long term trend reporting, which may include providing performance improvement recommendations. Some of the monitor functionality may be performed by the regulator, which is described in the next paragraph.

3) Regulator (block 415): This component dynamically adjusts system settings and/or projects performance issues and either alerts the DBA or user to take action, for example, by communication through the monitor 410, which is capable of providing alerts, or through the exception log, providing a way for applications and their users to become aware of and take action on, regulator actions. Alternatively, the regulator 415 can automatically take action by deferring requests or executing requests with the appropriate priority to yield the best solution given requirements defined by the administrator 405.

The administrator 405 is responsible for determining (i.e., recommending) the appropriate application settings based on SLGs. Such activities as setting weights, managing active work tasks and changes to any and all options will be automatic and taken out of the hands of the DBA. The user will be masked from all complexity involved in setting up the priority scheduler, and be freed to address the business issues around it.

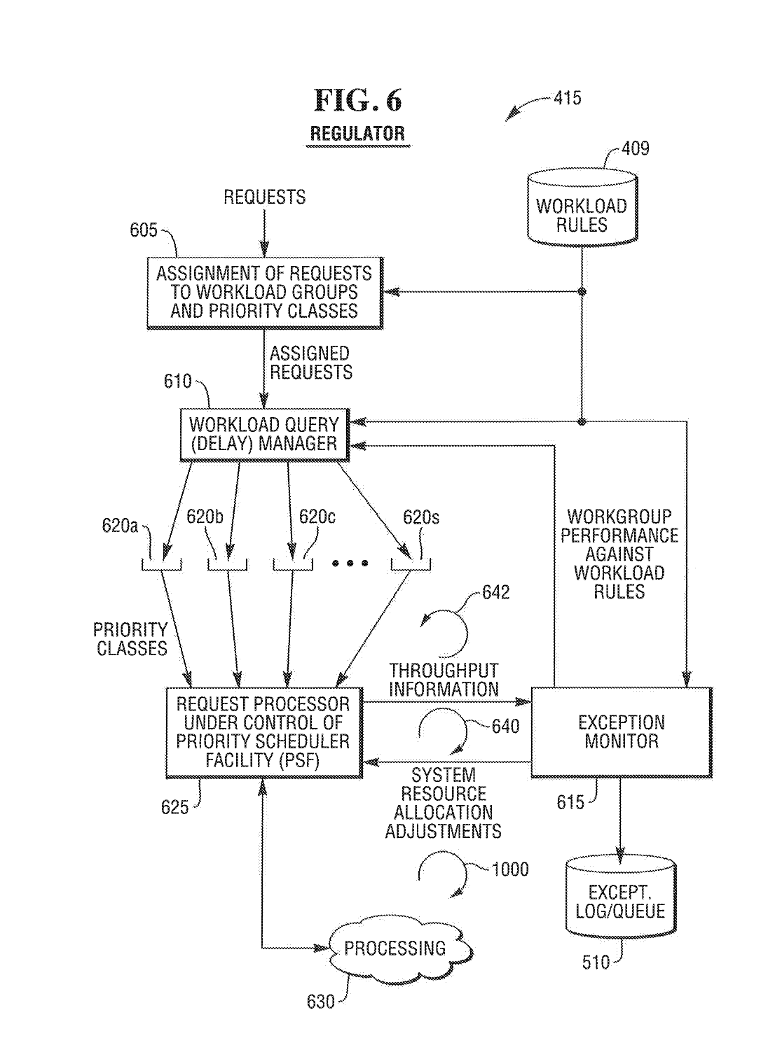

As shown in FIG. 5, the administrator 405 allows the DBA to establish workload rules, including SLGs, which are stored in a storage facility 409, accessible to the other components of the system. The DBA has access to a query log 505, which stores the steps performed by the DBS in executing a request along with database statistics associated with the various steps, and an exception log/queue 510, which contains records of the system's deviations from the SLGs established by the administrator. With these resources, the DBA can examine past performance and establish SLGs that are reasonable in light of the available system resources. In addition, the system provides a guide for creation of workload rules 515 which guides the DBA in establishing the workload rules 409 which may include Resource Limit rules. The guide 515 accesses the query log 505 and the exception log/queue 510 in providing its guidance to the DBA.

The administrator 405 assists the DBA in:

1) Establishing rules for dividing requests into candidate workload groups, and creating workload group definitions and Resource Limit rules. Requests with similar characteristics (users, application, table, resource requirement, etc.) are assigned to the same workload group. The system supports the possibility of having more than one workload group with similar system response requirements.

2) Refining the workload group definitions and defining SLGs for each workload group. The system provides guidance to the DBA for response time and/or arrival rate threshold setting by summarizing response time and arrival rate history per workload group definition versus resource utilization levels, which it extracts from the query log (from data stored by the regulator 415, as described below), allowing the DBA to know the current response time and arrival rate patterns. The DBA can then cross-compare those patterns to satisfaction levels or business requirements, if known, to derive an appropriate response time and arrival rate threshold setting, i.e., an appropriate SLG. After the administrator 405 specifies the SLGs, the system automatically generates the appropriate resource allocation settings, as described below. These SLG requirements are distributed to the rest of the system as workload rules.

3) Optionally, establishing priority classes and assigning workload groups to the classes. Workload groups with similar performance requirements are assigned to the same class. d) Providing proactive feedback (i.e., Validation) to the DBA regarding the workload groups and their SLG assignments prior to execution to better assure that the current assignments can be met, i.e., that the SLG assignments as defined and potentially modified by the DBA represent realistic goals. The DBA has the option to refine workload group definitions and SLG assignments as a result of that feedback.

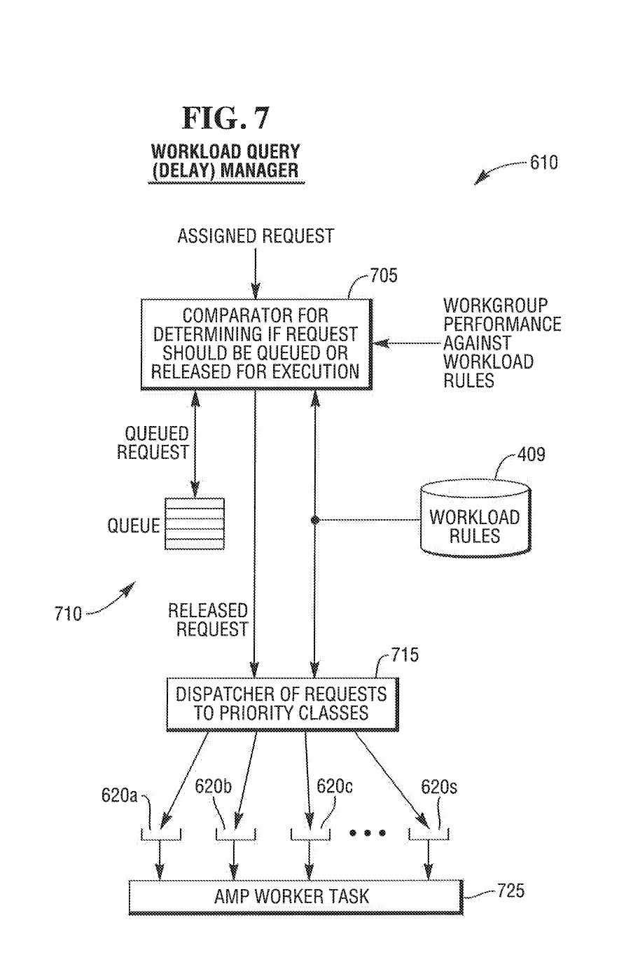

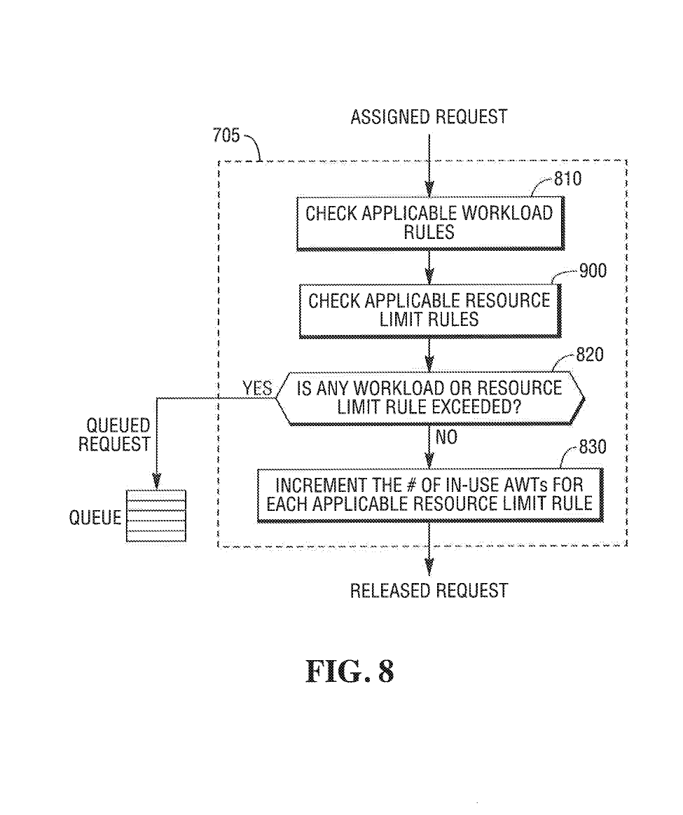

As shown in FIG. 6, the regulator 415 receives one or more requests, each of which is assigned by an assignment process (block 605) to a workload group and, optionally, a priority class, in accordance with the workload rules 409. The assigned requests are passed to a workload query (delay) manager 610, which is described in more detail with respect to FIG. 7. in general, the workload query (delay) manager 610 monitors the workload performance compared to the workload rules and either allows the request to be executed immediately or holds it for later execution, as described below. If the request is to he executed immediately, the workload query (delay) manager 610 places the request in the priority class bucket 620a . . . s corresponding to the priority class to which the request was assigned by the administrator 405. A request processor 625 under control of a priority scheduler facility (PSF) selects queries from the priority class buckets 620a . . s in an order determined by the priority associated with each of the buckets, and executes it, as represented by the processing block 630 of FIG. 6.

The request processor 625 also monitors the request processing and reports throughput information, for example, for each request and for each workgroup, to an exception monitoring process 615. The exception monitoring process 615 compares the throughput with the workload rules 409 and stores any exceptions (e.g., throughput deviations from the workload rules) in the exception log/queue 510. In addition, the exception monitoring process 615 provides system resource allocation adjustments to the request processor 625, which adjusts system resource allocation accordingly, e.g., by adjusting the priority scheduler weights. Further, the exception monitoring process 615 provides data regarding the workgroup performance against workload rules to the workload query (delay) manager 610, which uses the data to determine whether to delay incoming requests, depending on the workload group to which the request is assigned.

As can be seen in FIG. 6, the system provides three feedback loops 640, 642, and 1000, indicated by the circular arrows shown in the drawing. The first feedback loop 640 includes the request processor 625 and the exception monitoring process 615. In this first feedback loop 640, the system monitors on a short-term basis the execution of requests to detect deviations greater than a short-term threshold from the defined service level for the workload group to which the requests were defined. If such deviations are detected, the DBS is adjusted, e.g., by adjusting the assignment of system resources to workload groups.

The second feedback loop 642 includes the workload query (delay) manager 610, the request processor 625 and the exception monitoring process 615. In this second feedback loop 642, the system monitors on along-term basis to detect deviations from the expected level of service greater than a long-term threshold. If it does, the system adjusts the execution of requests, e.g., by delaying, swapping out or aborting requests, to better provide the expected level of service. Note that swapping out requests is one form of memory control in the sense that before a request is swapped out, it consumes memory, and after it is swapped out, it does not. While this is the preferable form of memory control, other forms, in which the amount of memory dedicated to an executing request can be adjusted as part of the feedback loop, are also possible.

The third feedback loop 1000 includes the request processor 625 and the processing block 630. In this third feedback loop 1000, the system monitors on a short-term basis active DSA jobs finishing and active Restore jobs either finishing or transitioning and needing less AWTs. Depending upon the particular job, the number of in-use AWTs is decremented for each applicable Resource Limit rule. In addition, the third feedback loop 1000 includes processing jobs which have been queued, and incrementing the number of in-use AWTs for each applicable Resource Limit rule accordingly.

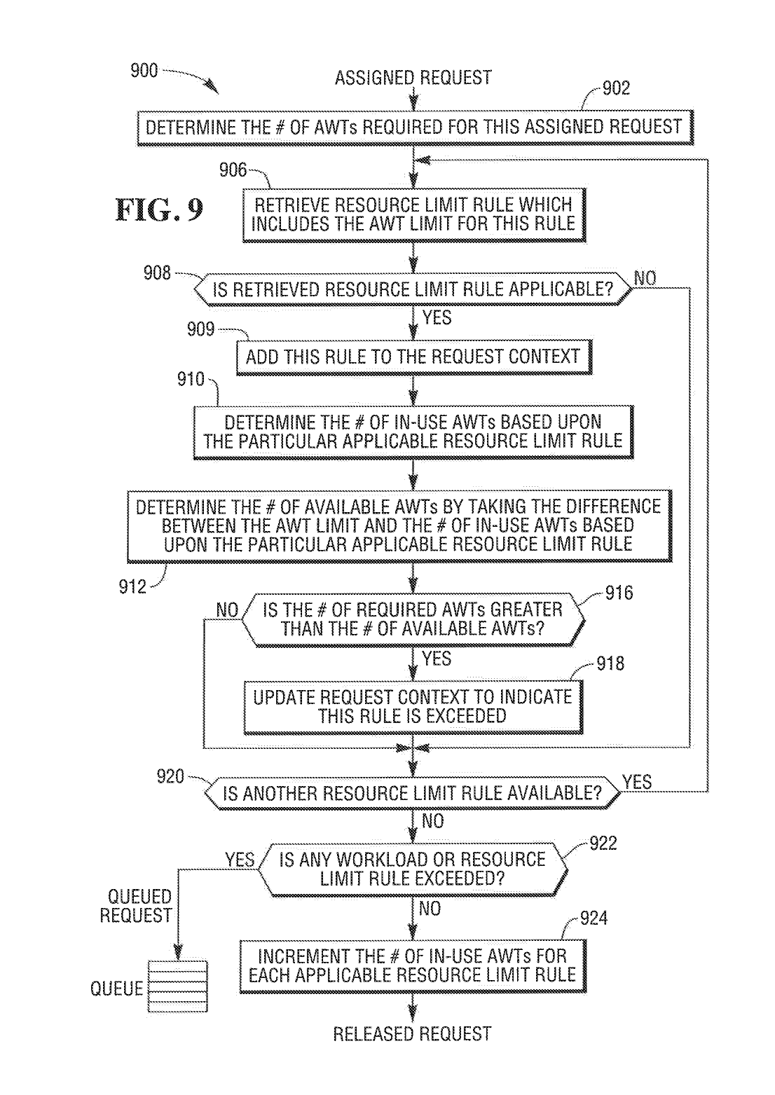

The workload query (delay) manager 610, shown in greater detail in FIG. 7, receives an assigned request as an input, A comparator 705 determines if the request should be queued or released for execution. It does this by determining the workload group assignment for the request and comparing that workload group's performance against the workload rules, provided by the exception monitoring process 615, and verifying that no applicable Resource Limit rule is exceeded as will be described later with reference to the flowchart of FIG. 8. For example, the comparator 705 may examine the concurrency level of requests being executed under the workload group to which the request is assigned, and check that available resources based upon applicable Resource Limit rules are sufficient. Further, the comparator may compare the workload group's performance against other workload rules.

If the comparator 705 determines that the request should not be executed, it places the request in a queue 710 along with any other requests for which execution has been delayed. The comparator 705 continues to monitor the workgroup's performance against the workload rules and when it reaches an acceptable level, it extracts the request from the queue 710 and releases the request for execution. In some cases, it is not necessary for the request to be stored in the queue to wait for workgroup performance to reach a particular level, in which case it is released immediately for execution. Once a request is released for execution it is dispatched (block 715) to priority class buckets 620a . . . s, where it will await retrieval by an Access Module Processor Worker Task (AWT) 725.

The exception monitoring process 615, receives throughput information from the AWT 725, The workload performance to workload rules comparator 705 compares the received throughput information to the workload rules and logs any deviations that it finds in the exception log/queue 510, It also generates the workload performance against workload rules information that is provided to the workload query (delay) manager 610.

As stated above, a series of AWTs process the requests. An AWT is a thread/task that runs inside of each virtual Access Module Processor (AMP). An AWT is generally utilized to process requests/queries from users, but may also be triggered or used by internal database software routines, such as deadlock detection.

Pre-allocated AWTs are assigned to each AMP and work on a queue system. That is, each AWT waits for work to arrive, performs the work, and then returns to the queue and waits for more work. Due to their stateless condition, AWTs respond quickly to a variety of database execution needs. At the same time, AWTs serve to limit the number of active processes performing database work within each AMP at any point in time. In other words, AWTs play the role of both expeditor and governor of requests/queries.

AWTs are one of several resources that support the parallel performance architecture within the database system. AWTs are of a finite number, with a limited number available to perform new work on the system. This finite number is an orchestrated part of the internal work flow management, Reserving a special set of reserve pools for single and few AMP queries may be beneficial for active data warehouse applications, but only after establishing a need exists. Understanding and appreciating the role of AWTs, both in their availability and their scarcity, leads to the need for a more pro-active management of AWTs and their usage.

AWTs are execution threads that do the work of executing a query step, once the step is dispatched to the AMP. They also pick up the work of spawned processes, and of internal tasks such as error logging or aborts. Not being tied to a particular session or transaction, AWTs are anonymous and immediately reusable and are able to take advantage of any of the CPUs. Both AMPs and AWTs have equal access to any CPU on the node. A fixed number of AWTs are pre-allocated at startup for each AMP in the configuration, with the default number being, for example, 80. All of the allocated AWTs can be active at the same time, sharing the CPUs and memory on the node.

When a query step is sent to an AMP, that step acquires a worker task from the pool of available AWTs. All of the information and context needed to perform the database work is contained within the query step. Once the step is complete, the AWT is returned to the pool. If all AWTs are busy at the time the message containing the new step arrives, then the message will wait in a queue until AWT is free. Position in the queue is based first on work type, and secondarily on priority, which is carried within the message header. Priority is based on the relative weight that is established for the Priority Scheduler allocation group that controls the query step. Too much work can flood the best of databases. Consequently, all database systems have built-in mechanisms to monitor and manage the flow of work in a system. In a parallel database, flow control becomes even more pressing, as balance is only sustained when all parallel units are getting their fair portion of resources.

The disclosed database system is able to operate near the resource limits without exhausting any of them by applying control over the flow of work at the lowest AWTs being one. If no AWTs are available, it places the incoming messages on a queue. If messages waiting in the queue for an AWT reach a threshold value, further message delivery is throttled for that AMP, allowing work already underway to complete. Other AMPs continue to work as usual.

One technique that has proven highly effective in helping the disclosed database system to weather extremely heavy workloads is having a reasonable limit on the number of active tasks on each AMP. The theory behind setting a limit on AWTs is twofold: 1) that it is better for overall throughput to put the brakes on before exhaustion of all resources is reached, and 2) keeping all AMPs to a reasonable usage level increases parallel efficiency. However this is not a reasonable approach in a dynamic environment.

Ideally, the minimum number of AWTs that can fully utilize the available CPU and I/O are employed. After full use of resources has been attained, adding AWTs will only increase the effort of sharing. As standard queuing theory teaches, when a system has not reached saturation, newly-arriving work may get in, use its portion of the resources, and get out efficiently. However, when resources are saturated, all newly-arriving work experiences delays equal to the time it takes someone else to finish their work. In the disclosed database system, the impact of any delay due to saturation of resources may be aggravated in cases where a query has multiple steps, because there will be multiple places where a delay could be experienced.

In one particular implementation of the disclosed database system, eighty is selected as the maximum number of AWTs to provide the best balance between AWT overhead and contention and CPU and I/O usage. Historically, eighty AWTs has worked well as a number that makes available a reasonable number of AWTs for all the different work types, and yet supports up to 40 or 50 new tasks per AMP comfortably. However, managing AWTs is not always a solution to increased demands on the DBS. In some cases, an increased demand on system resources may have an underlying cause, such that simply increasing the number of available AWTs may only serve to temporarily mask, or even worsen, the demand on resources.

For example, one of the manifestations of resource exhaustion is a lengthening queue for processes waiting for AWTs, Therefore, performance may degrade coincident with a shortage of AWTs. However, this may not be directly attributable to the number of AWTs defined. In this case, adding AWTs will tend to aggravate, not reduce, performance issues.

Using all eighty AWTs in an on-going fashion is a symptom that resource usage is being sustained at a very demanding level. It is one of several signs that the platform may be running out of capacity. Adding AWTs may be treating the effect, but not helping to identify the cause of the performance problem. On the other hand, in some instances, some database systems may reach 100% CPU utilization with significantly less than fifty active processes of the new work type. Some sites experience their peak throughput when forty AWTs are in use servicing new work. By the time many systems are approaching the limit of eighty AWTs, they are already at maximum levels of CPU usage.

In the case where the number of AWTs is reaching their limit, it is likely that a lack of AWTs is merely a symptom of a deeper underlying problem or bottleneck. Therefore, it is necessary to carry out a more thorough investigation of all events in the DBS in an attempt to find the true source of any slowdowns. For example, the underlying or “real” reason for an increase in the number of AWTs may be that too many requests with high AWT requirements are submitted concurrently. After the underlying problem is identified, it may be possible to create Resource Limit rules to prevent the problem.

Another issue that can impact system-wide performance is a workload event, such as the beginning or conclusion of a load or another maintenance job that can introduce locks or other delays into the DBS or simply trigger the need to change the workload management scheme for the duration of the workload event. The DBS provides a scheduled environment that manages priorities and other workload management controls in operating “windows” that trigger at certain times of the day, week, and/or month, or upon receipt of a workload event.

During operation of the database system, a user (such as the DBA) can monitor and manage resource usage across different parallel components of the system. The resource usage may comprise CPU usage, disk I/O usage, memory usage, AWT usage, or network usage. In accordance with disclosed embodiments, a routine is provided for enabling a user to monitor and manage resource usage across different components of a large database system.

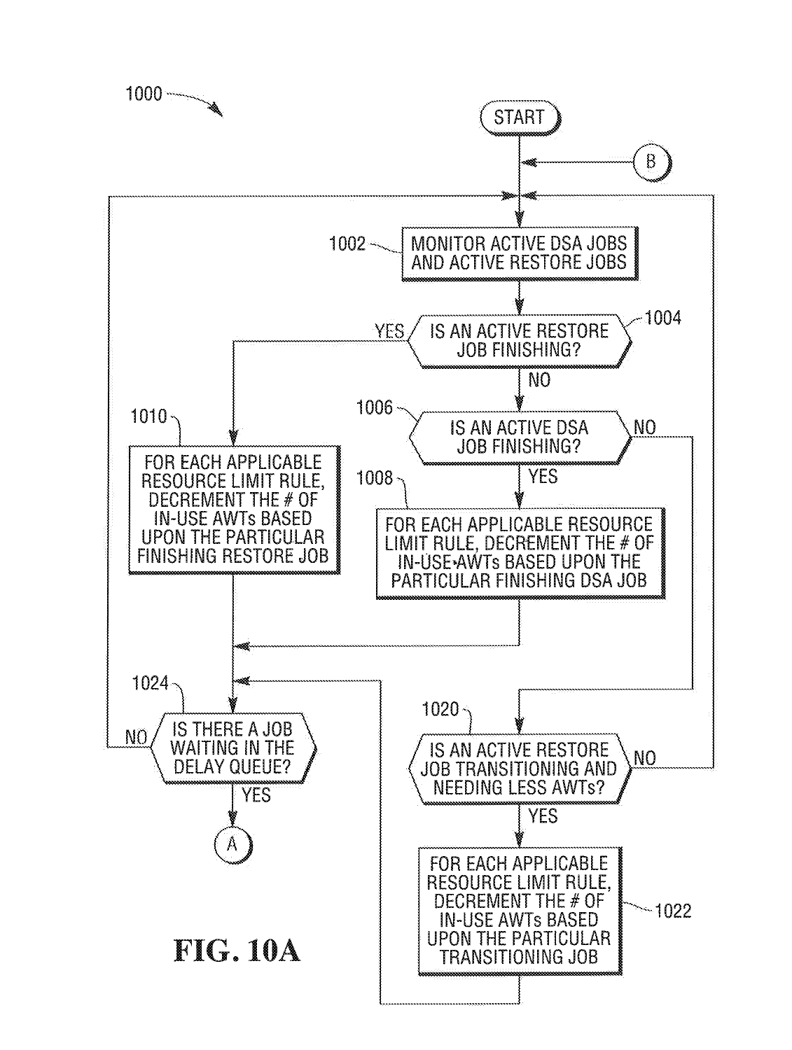

FIG. 8 is a flowchart associated with the comparator 705 (FIG. 7) that depicts processing of an example routine to facilitate incrementing the number of in-use AWTs when a job or request is starting in accordance with disclosed embodiments. The processing steps of FIG. 8 may be implemented as computer-executable instructions tangibly embodied on a computer-readable medium executable by a processing system, such as one or more of the processing modules 110₁-110_{N} depicted in FIG. 1. As shown in FIG. 8, an assigned request is checked against applicable workload rules (step 810), and is then checked against applicable Resource Limit rules (step 900) as will be described in detail later with reference to flowchart 900 of FIG. 9. A determination is made in step 820 as to whether any workload or Resource Limit rule is exceeded. If the determination in step 820 is affirmative (i.e., a workload or Resource Limit rule is exceeded), then the request is placed in queue. However, if the determination in step 820 is negative (i.e., no workload or Resource Limit rule is exceeded), then the number of in-use AWTs for each applicable Resource Limit rule is incremented accordingly, as shown in step 830, before the request is released.

FIG. 9 is a flowchart that depicts processing of an example routine to facilitate determining if the number of required AWTs for an assigned request exceeds the number of available AWTs in accordance with disclosed embodiments. The processing steps of FIG. 9 may be implemented as computer-executable instructions tangibly embodied on a computer-readable medium executable by a processing system, such as one or more of the processing modules 110₁-110_{N} depicted in FIG. 1.

In step 902, the number of required AWTs for the particular assigned request is determined. In step 906, a Resource Limit rule which includes the AWT limit for this rule is retrieved from storage memory. A determination is made in step 908 as to whether the retrieved Resource Limit rule is applicable to the particular request/job at hand. If the determination in step 908 is negative (i.e., the retrieved Resource Limit rule is not applicable), then the process proceeds directly to step 920. However, if the determination in step 908 is affirmative (i.e. the retrieved Resource Limit rule is applicable), then the process proceeds to step 909 in which this particular rule is added to the request context, The process then proceeds to step 910.

In step 910, the number of in-use AWTs is determined based upon the particular applicable Resource Limit rule. Then, in step 912, the number of available AWTs is determined by taking difference between the AWT Limit and the number of in-use AWTs determined in step 910. The process then proceeds to step 916 in which a determination is made as to whether the number of required AWTs is greater than the number of available AWTs, If the determination in step 916 is negative (i.e., the number of required AWTs is not greater than the number of available AWTs), then the process proceeds directly to step 920. However, if the determination in step 916 is affirmative (i.e., the number of required AWTs is greater than the number of available AWTs), then the process proceeds to step 918 to update request context to indicate that this particular rule is exceeded before proceeding to step 920.

Then, as shown in step 920, a determination is made as to whether there is another Resource Limit rule available to retrieve from storage memory. If the determination in step 920 is affirmative (i.e., there is another Resource Limit rule to retrieve from storage memory), then the process returns back to step 906 to retrieve the next Resource Limit rule from storage memory. However, if the determination in step 920 is negative (i.e., there is no other Resource Limit rule to retrieve from storage memory), then the process resumes at step 922. A determination is made in step 922 as to whether any workload or Resource Limit rule is exceeded. If the determination in step 922 is affirmative (i.e., a workload or Resource Limit rule is exceeded), then the request is placed in queue. However, if the determination in step 922 is negative (i.e., no workload or Resource Limit rule is exceeded), then the number of in-use AWTs for each applicable Resource Limit rule is incremented accordingly, as shown in step 924, before the request is released.

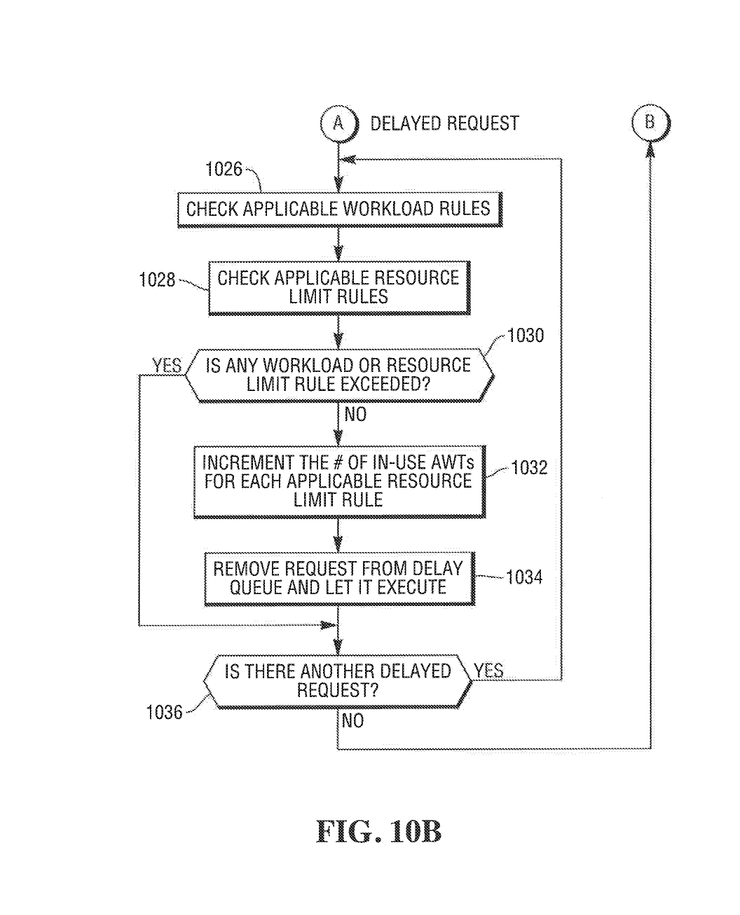

FIGS. 10A and 10B are a flowchart 1000 that depicts processing of an example routine to facilitate decrementing the number of in-use AWTs when a job or request is finishing or transitioning and incrementing the number of in-use AWTs when a delayed job or request is starting. The processing steps of FIGS. 10A and 10B may be implemented as computer-executable instructions tangibly embodied on a computer-readable medium executable by a processing system, such as one or more of the processing modules 110₁-110_{N} depicted in FIG. 1.

In step 1002, active DSA jobs are monitored, and active Restore jobs are monitored. A determination is made in step 1004 as to whether there is an active Restore job which is finishing. If the determination in step 1004 is affirmative (i.e., there is a Restore job which is finishing), then the process proceeds to step 1010. In step 1010, the number of in-use AWTs is decremented for each applicable Resource Limit rule to take into account that the particular active Restore job is finishing. The process then proceeds to step 1024.

However, if the determination in step 1004 is negative (i.e., there is no active Restore job which is finishing), then the process proceeds to step 1006. A determination is then made in step 1006 as to whether there is an active DSA job which is finishing. If the determination in step 1006 is affirmative (i.e., there is an active DSA job which is finishing), then the process proceeds to step 1008. In step 1008, the number of in-use AWTs is decremented for each applicable Resource Limit rule to take into account that the particular active DSA job is finishing. The process then proceeds to step 1024.

However, if the determination in step 1006 is negative (i.e., there is no active DSA job which is finishing), then the process proceeds to step 1020 in which a determination is made as to whether there is an active Restore job which is transitioning and needing less AWTs. If the determination in step 1020 is negative (i.e., there is no active Restore job which is transitioning and needing less AWTs), then the process proceeds back to step 1002 to continue monitoring active DSA jobs and active Restore jobs. However, if the determination in step 1020 is affirmative (i.e., there is an active Restore job which is transitioning and needing less AWTs), then the process proceeds to step 1022. In step 1022, the number of in-use AWTs is decremented for each applicable Resource Limit rule to take into account that the particular active Restore job is transitioning and needing less AWTs. The process then proceeds to step 1024.

In step 1024, a determination is made as to whether there is a job or request waiting in the (delay) queue. If the determination in step 1024 is negative (i.e., there is no job or request in the queue), then the process proceeds back to step 1002 to continue monitoring active DSA jobs and active Restore jobs. However, if the determination in step 1024 is affirmative (i.e., there is a job or request in the queue), then the process proceeds to step 1026 to process the delayed job or request.

The delayed request is checked against applicable workload rules (step 1026), and is then checked against applicable Resource Limit rules (step 1028) in a similar manner as was previously described with reference to flowchart of FIG. 8. A determination is then made in step 1030 as to whether any workload or Resource Limit rule is exceeded. If the determination in step 1030 is affirmative (i.e., a workload or Resource Limit rule is exceeded), then the process proceeds directly to step 1036. However, if the determination in step 1030 is negative (i.e., no workload or Resource Limit rule is exceeded), then the number of in-use AWTs for each applicable Resource Limit rule is incremented accordingly, as shown in step 1032, before the request is removed from the queue and allowed to execute, as shown in step 1034. The process then proceeds to step 1036.

In step 1036, a determination is made as to whether there is another request in the delay queue. If the determination in step 1036 is affirmative (i.e., there is another request in the delay queue), then the process proceeds back to step 1026 to process the next request in the delay queue. However, if the determination in step 1036 is negative (i.e., there is not another request in the delay queue), then the process proceeds back to step 1002 to continue monitoring active DSA jobs and active Restore jobs.

In accordance with an embodiment, TASM supports a new rule type which is called “Resource Limit”. This new rule type allows a DBA to set an AWT limit for utilities based upon three factors: 1) utility type, 2) request source (user, account, etc.), and 3 query band.

Moreover, multiple Resource Limit rules can be defined. A utility job is checked against all applicable rules and it is allowed to start if its AWT requirement estimate does not exceed the number of available AWTs of any applicable rule. Otherwise, the utility job is put on a delay queue (or optionally rejected) until sufficient AWTs become available.

For example, a DBA may want to limit all DSA jobs to use at most 55 AWTs. In addition, five of these 55 AWTs are to he reserved for the DBA user. This problem can be solved by defining two Resource Limit rules as follows:

1) Resource Limit rule number one:
Utility type=DSA Backup or DSA Restore
AWL limit=55

2) Resource Limit rule number two:
Utility type=DSA Backup or DSA Restore
User=all users except the DBA user
AWT limit=50

It should be noted that Resource Limit rule number one sets AWT limit at 55 for all DSA jobs from all users, and that Resource Limit rule number two sets AWT limit at 50 for all DSA jobs from all users except the DBA user. Therefore, at least five AWTs are reserved for DSA jobs from the DBA user. Accordingly, in this example case, DSA jobs from the DBA user are only checked against Resource Limit rule number one while DSA jobs from other users are checked against both Resource Limit rules.

It should also be noted that the above-described two Resource Limit rules can be applied and accommodate a variety of concurrent job combinations. For instance, one job combination is one complex Restore job using 55 AWTs from the DBA user. Another job combination is one complex Restore job in the last phase (two AWTs), 11 simple Restore jobs (three AWTs per job), and 10 Backup jobs (two AWTs per job) from the DBA user. Yet another job combination is 25 Backup jobs (two AWTs per job) from users other than the DBA user, as per Resource Limit rule number two defined hereinabove.

It should be apparent that the above description describes a workload management solution which can be used to prevent depletion of different resource types. This is accomplished by managing the different resource types to prevent excessive usage of system resources by concurrent users. Also, multiple Resource Limit rules can be used to set different limits for different groups of requests.

it should further be apparent that the above-described Resource Limit rules are user-definable and customizable to fit a particular environment. User-defined Resource Limit rules are externalized to provide a flexible and customizable workload management solution. This is opposite to using internalized rules which is a “one size fits all” type of approach.

It should also be apparent that the above-described workload management solution can support a number of different scenarios. For example, the workload management solution can support a scenario in which resource requirement of a request/job remains constant. In another example, the workload management solution can support a scenario in which resource requirement of a request/job changes in the different execution phases. Yet in another example, the workload management solution can be dynamically adjusted if a more accurate estimate is available in a subsequent execution phase.

Although the above description describes TASM supporting AWT Resource Limit rules for managing utilities, it is conceivable that the same concept can be applied to support other types of resources including spool space, memory, and database request types, for examples. The apparatus and method are applicable to a wide variety of other types of resources including CPU usage, disk I/O usage, memory usage, or network usage, for examples.

It should be apparent that the above description describes an apparatus and method that facilitate performance enhancement of a database system which uses a SLG-driven workload management system. It is conceivable that the above-described apparatus and method may be applied to facilitate performance enhancement of any type of database system, including database systems which do not use a workload management system. Moreover, it is conceivable that the above-described apparatus and method may be applied to facilitate performance enhancement of any type of computer system which is other than a database system.

Each of the above-described flowchart 705 of FIG. 8, flowchart 900 of FIG. 9, and flowchart 1000 of FIG. 10 depicts process serialization to facilitate an understanding of disclosed embodiments and is not necessarily indicative of the serialization of the operations being performed. In various embodiments, the processing steps described in each of the flowcharts above may be performed in varying order, and one or more depicted steps may be performed in parallel with other steps. Additionally, execution of some processing steps of each of the flowcharts above may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer.

The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information.

Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

The text above described one or more specific embodiments of a broader invention. The invention also is carried out in a variety of alternative embodiments and thus is not limited to those described here. For example, while the invention has been described here in terms of a DBS that uses a massively parallel processing (MPP) architecture, other types of database systems, including those that use a symmetric multiprocessing (SMP) architecture, are also useful in carrying out the invention. Many other embodiments are also within the scope of the following claims.

What is claimed is:

1. An apparatus for managing usage of database system resources by concurrent database users of a database system, the apparatus comprising:
a processor; and
a storage device communicatively coupled with the processor, wherein the processor is programmed to
(i) determine a number of in-use Access Module Processor Worker Tasks (AWTs) based upon at least one system-defined or user-definable Resource Limit rule,
(ii) take a difference between the number of in-use AWTs and an AWT limit, and
(iii) set the difference equal to a number of available AWTs for a new database job or request.

2. An apparatus according to claim 1, wherein the processor is further programmed to
(iv) calculate a number of in-use Access Module Processor Worker Tasks (AWTs) available for a new database job or request,
(v) estimate a number of AWTs required for a new database job or request to be started,
(vi) increment the number of in-use AWTs based upon at least one system-defined or user-definable Resource Limit rule when a new database job or request is starting, and
(vii) decrement the number of in-use AWTs based upon at least one system-defined or user-definable Resource Limit rule when an active database job or request is finishing.

3. An apparatus according to claim 2, wherein at least one system-defined or user-definable Resource Limit rule is associated with one of database system resources such as spool space, memory, CPU usage, I/O usage, storage usage.

4. An apparatus according to claim 3, wherein at least one system-defined or user-definable Resource Limit rule is associated with the database system resource of utilities and other database request types.

5. An apparatus according to claim 2, wherein the processor is further programmed to
(viii) decrement the number of in-use AWTs based upon at least one system-defined or user-definable Resource Limit rule when an active database job or request is transitioning into a new execution phase which needs less AWTs than current estimate.

6. An apparatus according to claim 5, wherein at least one system-defined or user definable Resource Limit rule is associated with one of database system resources such as spool space, memory, CPU usage, I/O usage, storage usage.

7. An apparatus according to claim 6, wherein at least one system-defined or user-definable Resource Limit rule is associated with the database system resource of utilities and other database request types.

8. A method of managing usage of database system resources by concurrent database users of a database system, the method comprising:
electronically by a processor, determining a number of in-use Access Module Processor Worker Tasks (AWTs) based upon at least one system-defined or user-definable Resource Limit rule;
electronically by a processor, taking a difference between the number of in-use AWTs and an AWT limit; and
electronically by a processor, setting the difference equal to a number of available AWTs for a new database job or request.

9. A method according to claim 8, further comprising:
electronically by a processor, calculating a number of in-use Access Module Processor Worker Tasks (AWTs) available for a new database job or request;
electronically by a processor, estimating a number of AWTs required for a new database job or request to be started; and
electronically by a processor, incrementing the number of in-use AWTs based upon at least one system-defined or user-definable Resource Limit rule when a new database job or request is starting; and
electronically by a processor, decrementing the number of in-use AWTs based upon at least one system-defined or user-definable Resource Limit rule when an active database job or request is finishing.

10. A method according to claim 9, wherein at least one system-defined or user-definable Resource Limit rule is associated with one of database system resources such as spool space, memory, CPU usage, I/O usage, storage usage.

11. A method according to claim 10, wherein at least one system-defined or user-definable Resource Limit rule is associated with the database system resource of utilities and other database request types.

12. A method according to claim 9, further comprising:
electronically by a processor, decrementing the number of in-use AWTs based upon at least one system-defined or user-definable Resource Limit rule when an active database job or request is transitioning into a new execution phase which needs less AWTs than current estimate.

13. A method according to claim 12, wherein at least one system-defined or user-definable Resource Limit rule is associated with one of database system resources such as spool space, memory, CPU usage, I/O usage, storage usage.

14. A method according to claim 13, wherein at least one system-defined or user-definable Resource Limit rule is associated with the database system resource of utilities and other database request types.

15. A method according to claim 8, wherein the method is performed by a computer having a memory executing one or more programs of instructions which are tangibly embodied in a program storage medium readable by the computer.

16. An apparatus for managing usage of computer system resources by concurrent database users of a computer system, the apparatus comprising:
a storage device for storing a set of Resource Limit rules which are system-defined or user-definable and which allow an administrator to set resource usage limits based upon the set of Resource Limit rules; and
a processor for, based upon each rule of the set of Resource Limit rules, (i) incrementing a number which is indicative of an in-use resource based upon at least one system-defined or user-definable Resource Limit rule of the set of Resource Limit rules when a new computer job or request is starting, and (ii) decrementing the number which is indicative of an in-use resource based upon at least one system-defined or user-definable Resource Limit rule of the set of Resource Limit rules when a computer job or request is finishing or transitioning into a new execution phase and needing less resources.

17. An apparatus according to claim 16, wherein the computer system comprises a database system.

18. An apparatus according to claim 17, wherein the database system comprises a database system which uses a Service Level Goal (SLG)-driven workload management system.

19. A method according to the apparatus of claim 16, wherein the method is performed by the processor having a memory executing one or more programs of instructions which are tangibly embodied in a program storage medium readable by the processor.

20. A method according to the apparatus of claim 17, wherein the method is performed by the processor having a memory executing one or more programs of instructions which are tangibly embodied in a program storage medium readable by the processor.
